(19) United States
(12) Patent Application Publication
(10) Pub. No.: US 2026/0054313 A1
(43) Pub. Date: Feb. 26, 2026

(54) METHODS OF FORMING AND USING THREE-DIMENSIONAL STRUCTURES WITH OPEN PORE NETWORKS TO FORM SINTERED POLYCRYSTALLINE COMPACTS, AND COMPACTS FORMED BY SUCH METHODS

(71) Applicant: Baker Hughes Oilfield Operations LLC, Houston, TX (US)

(72) Inventors: Ahmed Hanafy, The Woodlands, TX (US); John Abhishek Raj Bomidi, Peral River, NY (US); Andrew Robertson, The Woodlands, TX (US)

(21) Appl. No.: 18/811,527

(22) Filed: Aug. 21, 2024

(51) Int. Cl. B22F 7/06; B22F 3/14; B22F 10/18; B33Y 10/00; B33Y 80/00

(52) U.S. Cl. CPC B22F 7/062; B22F 3/14; B33Y 10/00; B33Y 80/00; B22F 10/18; B22F 2302/406

(57) ABSTRACT

A method of forming a hard polycrystalline compact, such as a polycrystalline diamond compact, for use in an earth-boring tool includes forming a three-dimensional structure that has an open pore network. The three-dimensional structure includes at least one of a metal, metal alloy, or diamond grains. Particulate material is disposed within the three-dimensional structure. The particulate material also includes at least one of a metal, metal alloy, or diamond grains. The three-dimensional structure with the particulate material therein is then subjected to a high-temperature, high-pressure (HTHP) sintering process to form the hard polycrystalline compact.

### TECHNICAL FIELD

The present disclosure relates generally to methods of forming hard polycrystalline compacts, such as polycrystalline diamond compacts, to hard polycrystalline compacts formed using such methods, and to earth-boring tools including such hard polycrystalline compacts.

### BACKGROUND

Earth-boring tools for forming boreholes in subterranean earth formations, such as for hydrocarbon production, carbon dioxide sequestration, etc., generally include a plurality of cutting elements secured to a body. For example, fixed-cutter earth-boring rotary drill bits (also referred to as “drag bits”) include cutting elements fixed to a bit body of the drill bit. Similarly, roller cone earth-boring rotary drill bits may include cones mounted on bearing pins extending from legs of a bit body such that each cone is capable of rotating about the bearing pin on which it is mounted. A plurality of cutting elements may be mounted to each cone of the drill bit.

The cutting elements used in such earth-boring tools often include polycrystalline diamond compact (often referred to as “PDC”) cutting elements, which are cutting elements that include cutting faces of a polycrystalline diamond (PCD) material.

Polycrystalline diamond material is material that includes inter-bonded grains or crystals of diamond material. In other words, polycrystalline diamond material includes direct, inter-granular bonds between the grains or crystals of diamond material. The terms “grain” and “crystal”are used synonymously and interchangeably herein.

PDC cutting elements are formed by sintering and bonding diamond grains together under conditions of high pressure and temperature in the presence of a catalyst (e.g., cobalt, iron, nickel, or alloys and mixtures thereof) to form a layer or “table” of polycrystalline diamond material on a cutting element substrate. These processes are often referred to as high pressure/high temperature (or “HPHT”) processes. As shown in FIG. 1, a polycrystalline diamond table 10 may include fine diamond grains 12, coarse diamond grains 14, and an interstitial material 16, which is typically a metal solvent catalyst metal alloy (e.g., an iron-, cobalt-, or nickel-based alloy) and/or intermetallic compounds. The fine diamond grains 12 and coarse diamond grains 14 may be interspersed and inter-bonded. The cutting element substrate may comprise a cermet material (i.e., a ceramic-metal composite material) such as cobalt-cemented tungsten carbide. In such instances, the cobalt or other catalyst material in the cutting element substrate may be swept into the diamond grains during sintering and serve as the catalyst material 16 for forming the inter-granular diamond-to-diamond bonds between, and the resulting diamond table from, the diamond grains 12, 14 . In other methods, powdered catalyst material may be mixed with the diamond grains 12, 14 prior to sintering the grains together in an HPHT process.

Upon formation of a diamond table using an HPHT process, interstitial material 16 may remain in interstitial spaces between the grains of diamond 12, 14 in the resulting polycrystalline diamond table 10. The presence of the interstitial material 16 in the diamond table 10 may contribute to thermal damage in the diamond table 10 when the cutting element is heated due to friction at the contact point between the cutting element and the formation during use.

PDC cutting elements in which the interstitial material 16 remains in the diamond table 10 are generally thermally stable up to a temperature of about 750° C., although internal stress within the cutting element may begin to develop at temperatures exceeding about 400° C. due to phase changes in the metal catalyst (e.g., cobalt, which undergoes a transition from the beta phase to the alpha phase) and/or differences in the thermal expansion of the diamond grains 12, 14 and the interstitial material 16 at the grain boundaries. This difference in thermal expansion may result in relatively large tensile stresses at the interface between the diamond grains 12, 14, and may contribute to thermal degradation of the microstructure when PDC cutting elements are used in service. Differences in the thermal expansion between the diamond table 10 and the cutting element substrate to which it is bonded further exacerbate the stresses in the PDC. This differential in thermal expansion may result in relatively large compressive and/or tensile stresses at the interface between the diamond table 10 and the substrate that eventually lead to the deterioration of the diamond table 10, cause the diamond table to delaminate from the substrate, or result in the general ineffectiveness of the cutting element.

Furthermore, at temperatures at or above about 750° C., some of the diamond grains 12, 14 within the diamond table may react with the interstitial material 16, causing the diamond grains 12, 14 to undergo a chemical breakdown or conversion to another allotrope of carbon. For example, the diamond grains 12, 14 may graphitize at the diamond crystal boundaries, which may substantially weaken the diamond table 10. At extremely high temperatures, some of the diamond grains 12, 14 may be converted to carbon monoxide and/or carbon dioxide.

In order to reduce the problems associated with differences in thermal expansion and chemical breakdown of the diamond crystals in PDC elements, so-called “thermally stable” polycrystalline diamond compacts (which are also known as thermally stable products, or “TSPs”) have been developed. A TSP may be formed by leaching the interstitial material 16 (e.g., cobalt) out from interstitial spaces between the inter-bonded diamond crystals in the diamond table using, for example, an acid or combination of acids (e.g., aqua regia). A substantial amount of the interstitial material may be removed from the diamond table, or the interstitial material may be removed from only a portion thereof. TSPs in which substantially all interstitial material has been leached out from the diamond table have been reported to be thermally stable up to temperatures of about 1200° C. It has also been reported, however, that such fully leached diamond tables are relatively more brittle and vulnerable to shear, compressive, and tensile stresses than are non-leached diamond tables. In addition, it is difficult to secure a completely leached diamond table to a supporting substrate. In an effort to provide cutting elements having diamond tables that are more thermally stable relative to non-leached diamond tables, but that are also relatively less brittle and vulnerable to shear, compressive, and tensile stresses relative to fully leached diamond tables, cutting elements have been provided that include a diamond table in which the interstitial material has been leached from a portion or portions of the diamond table. For example, it is known to leach interstitial material from the cutting face, from the side of the diamond table, or both, to a desired depth within the diamond table, but without leaching all of the interstitial material out from the diamond table.

### BRIEF SUMMARY

In some embodiments, the present disclosure includes a method of forming a polycrystalline diamond compact for use in an earth-boring tool. In accordance with the method, a three-dimensional structure is formed that has an open pore network. The three-dimensional structure includes at least one of a metal, metal alloy, or diamond grains. Particulate material is disposed within the three-dimensional structure. The particulate material also includes at least one of a metal, metal alloy, or diamond grains. The three-dimensional structure with the particulate material therein is then subjected to a high-temperature, high-pressure (HTHP) sintering process to form the polycrystalline diamond compact.

According to other advantageous and non-limiting features of embodiments of the method, taken alone or in any technically feasible combination:

The three-dimensional structure may be formed using an additive manufacturing process that includes forming at least one layer of unconsolidated particulate matter, consolidating predetermined regions of the at least one layer of unconsolidated particulate matter using an energy beam, and removing remaining unconsolidated particulate matter from the at least one layer of unconsolidated particulate matter.

The three-dimensional structure may be formed using an additive manufacturing process that includes mixing particulate matter with an organic binder to form a slurry, the particulate matter comprising the at least one of a metal or metal alloy or diamond grains, and selectively depositing the slurry mixture at predetermined locations on a substrate using a nozzle, the organic binder solidifying upon deposition of the slurry mixture on the substrate to retain the particulate matter and the organic binder at the predetermined locations at which they were deposited.

The three-dimensional structure may be formed using a freeze-casting process.

The three-dimensional structure may have a first composition in a first region of the three-dimensional structure and a second composition different from the first composition in a second region of the three-dimensional structure.

The three-dimensional structure may include at least one of a metal or metal alloy, the three-dimensional structure being free of diamond grains.

The three-dimensional structure may include at least one of a metal or metal alloy and diamond grains.

The three-dimensional structure may include diamond grains and a binder, the three-dimensional structure being free of metal or metal alloy.

Subjecting the three-dimensional structure with the particulate material therein to the HTHP sintering process to form the polycrystalline diamond compact may further include forming a first region of the polycrystalline diamond compact comprising a cutting edge of the polycrystalline diamond compact and forming a second region of the polycrystalline diamond compact remote from the cutting edge of the polycrystalline diamond compact. Interstitial spaces between interbonded diamond grains in the first region may be occupied with a first interstitial composition, and interstitial spaces between interbonded diamond grains in the second region may be occupied with a second interstitial composition different from the first interstitial composition.

The three-dimensional structure may have a lattice structure.

The three-dimensional structure may have a random structure.

The three-dimensional structure may include a metal alloy including one or more Group VIII metal elements. The metal alloy may further include one or more metal elements selected from among the group consisting of Ti, Zr, V, Nb, Ta, Cr, Mo, W, Mn, Re, Ru, Cu, Ag, Au, Zn, Ge, and Al. The metal alloy further include one or more non-metal elements selected from among the group consisting of Mg, Ca, B, C, Si, N, P, O, and S.

Additional embodiments of the present disclosure include a method of forming a polycrystalline diamond compact for use in an earth-boring tool, in which a three-dimensional structure comprising an open pore network is provided. The three-dimensional structure includes at least one of a metal or metal alloy or diamond grains. Particulate material is provided within the three-dimensional structure. The three-dimensional structure with the particulate material therein is then subjected to a high-temperature, high-pressure (HTHP) sintering process to form the polycrystalline diamond compact.

According to other advantageous and non-limiting features of embodiments of the method, taken alone or in any technically feasible combination:

The three-dimensional structure has a first composition in a first region of the three-dimensional structure and a second composition different from the first composition in a second region of the three-dimensional structure.

The three-dimensional structure includes at least one of a metal or metal alloy, the three-dimensional structure being free of diamond grains.

The three-dimensional structure includes at least one of a metal or metal alloy and diamond grains.

The three-dimensional structure includes diamond grains and a binder, the three-dimensional structure being free of metal or metal alloy.

The three-dimensional structure comprises a metal alloy including one or more Group VIII metal elements.

Additional embodiments of the present disclosure include hard polycrystalline compacts formed using methods as described herein.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a simplified drawing showing how a conventional polycrystalline material may appear under magnification, and illustrates inter-bonded grains of hard material;

FIG. 2 illustrates an embodiment of a polycrystalline compact of the current disclosure;

FIG. 3 illustrates a three-dimensional lattice structure comprising an open pore network, which may be formed and used in accordance with embodiments of methods of forming a hard polycrystalline compact as described herein;

FIG. 4 is a partially cut-away view of the three-dimensional lattice structure of FIG. 3;

FIG. 5 illustrates another three-dimensional lattice structure comprising an open pore network, which may be formed and used in accordance with embodiments of methods of forming a hard polycrystalline compact as described herein;

FIG. 6 schematically illustrates portions of three different lattice structures that have different volumetric percentages of open space within the open pore networks therein;

FIG. 7 schematically illustrates a portion of a lattice structure having different regions with different volumetric percentages of open space within the open pore network in the respective regions;

FIG. 8 schematically illustrates another three-dimensional structure having an open pore network therein, which may be formed and used in accordance with embodiments of methods of forming a hard polycrystalline compact as described herein;

FIG. 9 is a cross-sectional view illustrating a three-dimensional structure having an open poor network filled with particulate material and encapsulated in a container in preparation for sintering the assembly in accordance with embodiments of methods of the present disclosure; and

FIG. 10 is a perspective view of an embodiment of a fixed-cutter earth-boring rotary drill bit that includes a plurality of polycrystalline compacts like the polycrystalline compact shown in FIG. 2.

### DETAILED DESCRIPTION

The illustrations presented herein are not actual views of any particular hard polycrystalline compact, microstructure of polycrystalline material, particles, or earth-boring tool, and are not drawn to scale, but are merely idealized representations employed to describe embodiments of the disclosure. Elements common between figures may retain the same numerical designation.

As used herein, the term “earth-boring tool” means and includes any type of tool used for drilling during the formation or enlargement of a wellbore and includes, for example, rotary drill bits, percussion bits, core bits, eccentric bits, bicenter bits, reamers, expandable reamers, mills, drag bits, roller cone bits, hybrid bits, and other drilling bits and tools known in the art.

The term “polycrystalline material” means and includes any material comprising a plurality of grains (i.e., crystals) of the material that are bonded directly together by inter-granular bonds. The crystal structures of the individual grains of the material may be randomly oriented in space within the polycrystalline material.

As used herein, the term “inter-granular bond” means and includes any direct atomic bond (e.g., ionic, covalent, metallic, etc.) between atoms in adjacent grains of material.

As used herein, the term “grain size” means and includes a geometric mean diameter measured from a 2D section through a bulk material. The geometric mean diameter for a group of particles may be determined using techniques known in the art, such as those set forth in Ervin E. Underwood, Quantitative Stereology, 103-105 (Addison-Wesley Publishing Company, Inc. 1970), which is incorporated herein in its entirety by this reference.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

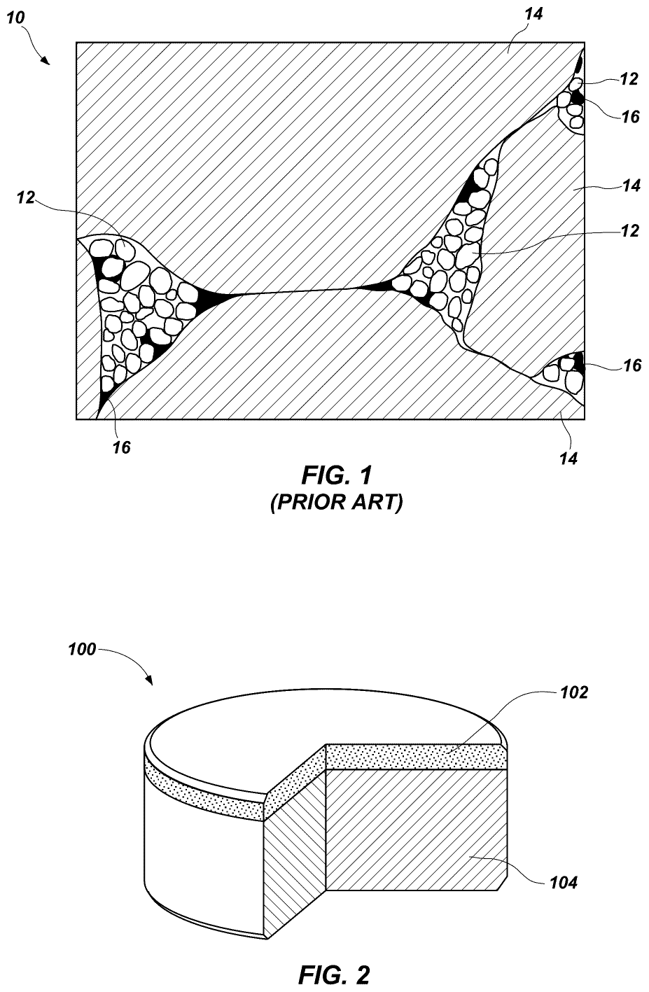

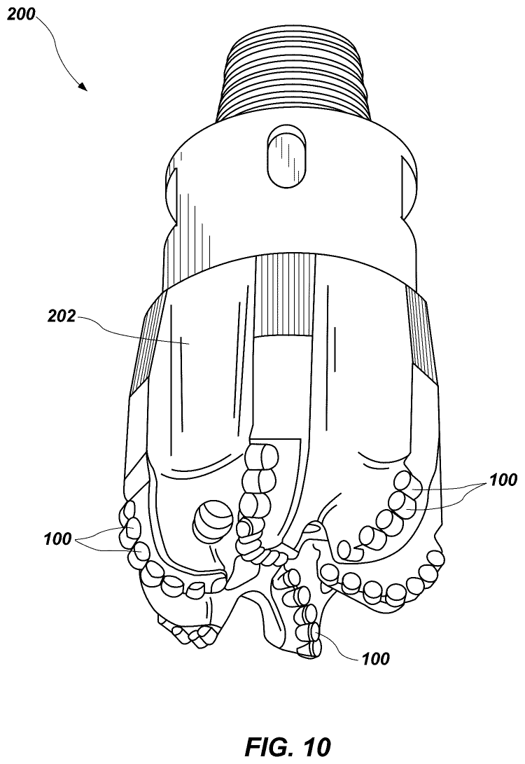

Embodiments of the present disclosure include methods of forming hard polycrystalline compacts, such as the polycrystalline diamond compact 100 shown in FIG. 2. Such a polycrystalline diamond compact 100 may be used in an earth-boring tool, such as the earth-boring rotary drill bit 200 subsequently described herein with reference to FIG. 10.

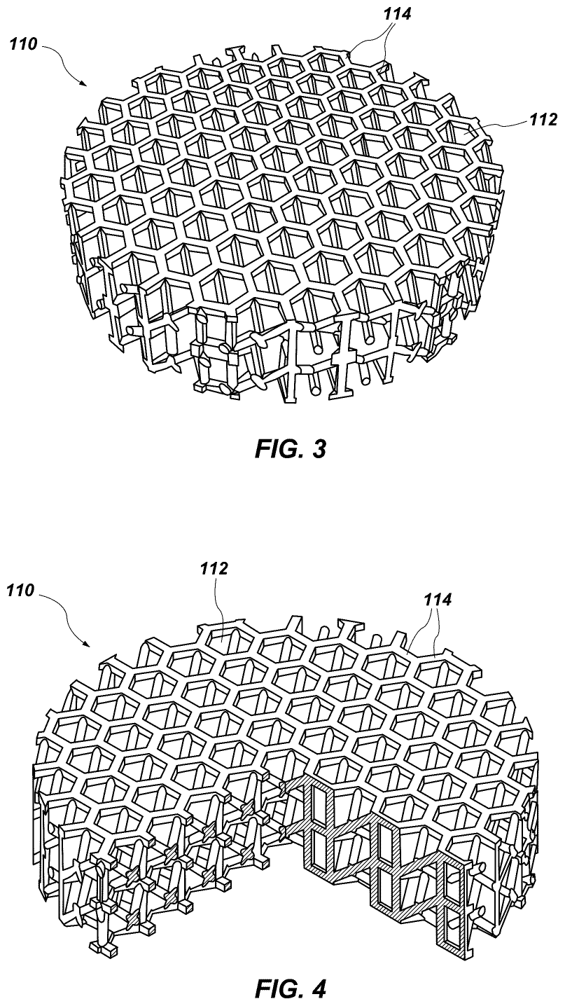

As is discussed in further detail below with reference to FIGS. 3-9, in accordance with embodiments of methods of the present disclosure, a three-dimensional structure is formed that has an open pore network, particulate material is then disposed within the open pore network of the three-dimensional structure, and then the lattice structure with the particulate material therein is subjected to a high-temperature, high-pressure (HTHP) sintering process to form the hard polycrystalline compact.

Referring initially to FIG. 2, the polycrystalline diamond compact 100 includes a table or layer of hard polycrystalline material 102 that has been provided on (e.g., formed on or secured to) a surface of a supporting substrate 104. For example, the substrate 104 may include a generally cylindrical body of cobalt-cemented tungsten carbide material, although substrates of different geometries and compositions also may be employed. In additional embodiments, the polycrystalline diamond compact 100 may simply comprise a volume of the hard polycrystalline material 102 having any desirable shape and may not include any supporting substrate 104.

In some embodiments, the hard polycrystalline material 102 comprises polycrystalline diamond. In other embodiments, the hard polycrystalline material 102 may comprise another hard material, such as cubic boron nitride, silicon nitride, silicon carbide, titanium carbide, tungsten carbide, tantalum carbide, or another hard material. The hard polycrystalline material may comprise what is referred to in the industry as a “superabrasive” material.

As previously discussed in relation to FIG. 1, the microstructure of the hard polycrystalline material 102 of the compact 100 (FIG. 2) may include grains of the hard polycrystalline material. The grains of hard polycrystalline material may have a monomodal grain size distribution or a multi-modal (e.g., bi-modal, tri-modal, etc.) grain size distribution. In other words, the hard polycrystalline material 102 may include a first plurality of fine grains 12 of hard material having a first average grain size, and at least a second plurality of course grains 14 of hard material having a second average grain size that differs from the first average grain size of the first plurality of fine grains 12, such that a plot of the number of grains as a function of grain size has at least two peaks. The microstructure of the hard polycrystalline material 102 may further include an interstitial material 16 disposed in the interstitial spaces between the grains 12, 14 of hard material, which may include a metal-solvent catalyst metal or metal alloy (e.g., an iron-, cobalt-, or nickel-based alloy) and/or intermetallic compounds.

FIG. 3 illustrates a three-dimensional lattice structure 110 comprising an open pore network 112, which may be formed and used to form the polycrystalline diamond compact 100 of FIG. 2.

The three-dimensional lattice structure 110 may be formed using an additive manufacturing process. Various additive manufacturing processes are known, and any suitable additive manufacturing process may be used, such as Direct Metal Laser Sintering (DMLS), Electron beam melting (EBM), Selective heat sintering (SHS), Selective laser melting (SLM) Selective laser sintering (SLS), Binder Jetting, or Freeze Casting.

For example, in some embodiments, the additive manufacturing process may include forming at least one layer of unconsolidated particulate matter and consolidating predetermined regions of the at least one layer of unconsolidated particulate matter using an energy beam, such as an ion beam or a laser beam. This process may be repeated any number of times, so as to form the three-dimensional lattice structure 110 in a layer-by-layer process. As each predetermined region in each layer is consolidated, it is consolidated with the underlying previously consolidated predetermined regions. Then, the remaining unconsolidated particulate matter may be removed, so as to reveal the open pore network 112 within the three-dimensional lattice structure 110.

In additional embodiments, the additive manufacturing process may include mixing particulate matter with an organic binder to form a slurry, and selectively depositing the slurry mixture at predetermined locations on a substrate using a nozzle. The organic binder is solidified upon deposition of the slurry mixture on the substrate to retain the particulate matter and the organic binder at the predetermined locations at which they were deposited. If desirable or necessary, the three-dimensional structure 110 may be heated to remove the organic binder prior to subjecting the three-dimensional structure 110 to the HTHP sintering process.

In additional embodiments, the additive manufacturing process may include providing a think layer of particulate material on a support, and selectively injecting liquid organic binder into the thin layer of particulate material at predetermined locations using a nozzle. The liquid binder may be solidified upon or after deposition to retain the particulate matter at the predetermined locations at which the binder was deposited. This process may be repeated any number of times in a layer-by-layer deposition process. If desirable or necessary, the three-dimensional structure 110 may be heated to remove the organic binder prior to subjecting the three-dimensional structure 110 to the HTHP sintering process.

The composition of the three-dimensional structure 110 may be varied as desired to achieve a desired composition in the resulting polycrystalline diamond compact 100. The three-dimensional structure 110 may comprise metal particles, metal alloy particles, hard particles (e.g., diamond grains), or a mixture of such particles. In some embodiments, the three-dimensional structure 110 may comprise only metal or metal alloy, and no hard particles. In other embodiments, the three-dimensional structure 110 may include hard particles and no metal or metal alloy. In yet further embodiments, the three-dimensional structure 110 may include a mixture of metal or metal alloy and hard particles. As a non-limiting example, the three-dimensional structure 110 may comprise diamond particles and particles of one or more Group VIII metal elements, such as a cobalt-, iron-, or nickel-based alloy. Such a metal alloy may further include one or more metal elements such as Ti, Zr, V, Nb, Ta, Cr, Mo, W, Mn, Re, Ru, Cu, Ag, Au, Zn, Ge, or Al. Non-metal elements may also be included, such as Mg, Ca, B, C, Si, N, P, O, or S.

Whatever the composition, the particles may have average grain sizes of between 10 nm and 100μm, between 50 nm and 50μm, or even between 100 nm and 10μm.

The relative weight or volume percentages for the diamond and metal alloy particles may range from 0% metal alloy particles and 100% diamond particles to 100% metal alloy particles and 0% diamond particles.

The three-dimensional structure 110 also may include additives, such as organic solvents, plasticizers, etc., which may be used to bind the particles together in the three-dimensional structure 110 and otherwise assist in the formation of the three-dimensional structure 110 in accordance with the manufacturing process(es) used to form the three-dimensional structure 110.

Additionally, the composition of the three-dimensional structure 110 may be substantially homogenous through the three-dimensional structure 110, or the composition may be selectively varied between different regions of the three-dimensional structure 110. For example, the percentage of hard particles may be higher in areas closer to the edges or exterior surfaces of the three-dimensional structure 110 relative to the interior region of the three-dimensional structure 110, for example.

As can be seen with reference to FIG. 3, the three-dimensional structure 110 comprises interconnected trusses or beams 114 formed in an ordered three-dimensional array with gaps therebetween that define the open pore network 112 within the three-dimensional structure 110. The cross-sectional dimensions of the beams 114 may be between about 50 nm and about 10 millimeters, between about 100 nm and about 1,000μm, or even between about 1 μm and about 500μm. The average spacing between parallel beams 114 may be between about 500 nm and about 10 millimeters, between about 1μm and about 1,000μm, or even between about 20μm and about 750μm.

In the embodiment of FIG. 3, the three-dimensional structure 110 has a disc shape, and interconnected beams 114 in common horizontal planes form hexagonal shaped apertures therebetween. The horizontal planes of beams 114 are interconnected by vertically and diagonally extending beams, as can be seen in the partially cut-away view of the three-dimensional structure 110 shown in FIG. 4.

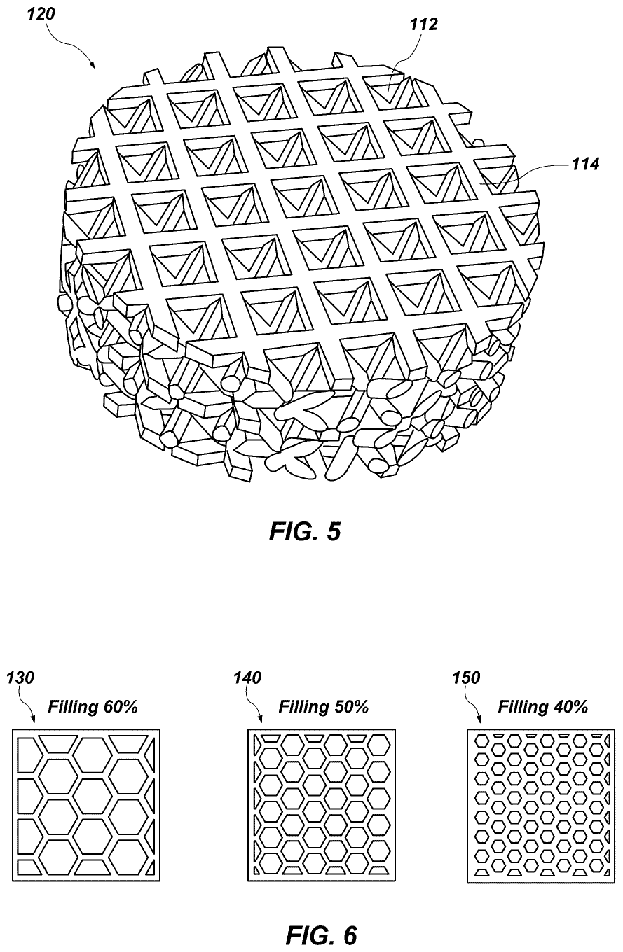

FIG. 5 illustrates another embodiment of a three-dimensional structure 120, which has interconnected beams 114 in common horizontal planes forming square shaped apertures therebetween. The horizontal planes of beams 114 are interconnected by vertically and diagonally extending beams as in the embodiment of FIG. 3. The three-dimensional structure 120 may have a composition as described in relation to the three-dimensional structure 110 of FIG. 3 and may also be formed in the same manner as previously described.

Any other geometries of beams 114, walls, layers, etc., may be used in additional embodiments of the disclosure, as long as the structure defines an open pore network 112 therein, which can be filled with particular material as described in further detail below.

The size and spacing of the beams 114 in the three-dimensional structures 110, 120 may be chosen so as to form the open pore network 112 to occupy a selected, predefined percentage of the total volume encompassed within the exterior surfaces of the three-dimensional structures 110, 120, which percentage may range between about 10% and about 90%, between about 20% and about 80%, or between about 30% and about 70%. For example, FIG. 6 illustrates a three-dimensional structure 130 in which the beams 114 have a size and spacing chosen such that the open pore network 112 occupies approximately 60% of the total volume encompassed within the exterior surfaces of the three-dimensional structure 130, a three-dimensional structure 140 in which the beams 114 have a size and spacing chosen such that the open pore network 112 occupies approximately 50% of the total volume encompassed within the exterior surfaces of the three-dimensional structure 140, and a three-dimensional structure 150 in which the beams 114 have a size and spacing chosen such that the open pore network 112 occupies approximately 40% of the total volume encompassed within the exterior surfaces of the three-dimensional structure 150.

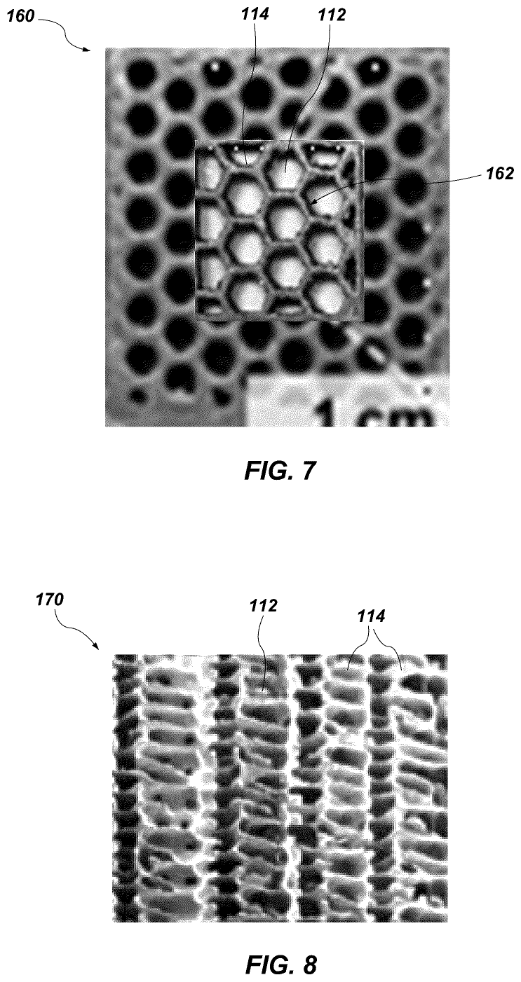

Furthermore, the size and spacing of the beams 114 may be substantially uniform throughout the three-dimensional structures, or the size and spacing of the beams 114 may be selectively varied between different regions. As a non-limiting example, FIG. 7 illustrates another embodiment of a three-dimensional structure 160, in which the beams 114 in a central region 162 of the three-dimensional structure 160 have a smaller beam width and wider spacing relative to beams 114 in surrounding regions of the three-dimensional structure 160.

The beams 114 of each of the previously described three-dimensional structures have a lattice structure in which the beams 114 are arranged in an ordered three-dimensional array. Such a lattice structure may include repeated geometric structures (e.g., rhombus, honeycomb, etc.). In other embodiments, however, a three-dimensional structure may have a random structure. For example, FIG. 8 illustrates a three-dimensional structure 170 having a random structure fabricated using a freeze-casting process, which is sometimes referred to as ice-casting. An example of such a process is described in S. Deville, Freeze-casting of porous ceramics: a review of current achievements and issues; Advanced Engineering Materials (2008); 10:155-169, which is incorporated herein by reference. The three-dimensional structure 170 also has beams 114 defining an open pore network 112 within the three-dimensional structure 170, although these beams 114 are irregularly and randomly shaped. The three-dimensional structure 170 may have a composition as described in relation to the three-dimensional structure 110 of FIG. 3, although it may be more difficult to control or vary the composition within the three-dimensional structure 170 due to the nature of the freeze-casting process.

After forming the three-dimensional structure as described previously herein, particulate material may be disposed within the open pore network of the three-dimensional structure, and then the three-dimensional structure with the particulate material therein may be subjected to a sintering process, such as a high-temperature, high-pressure (HTHP) sintering process to form a hard polycrystalline compact, such as the high-crystalline diamond compact 100 shown in FIG. 2. Optionally, the three-dimensional structure may be heated to remove any organic binder or other materials therein prior to subjecting the three-dimensional structure to the HTHP sintering process.

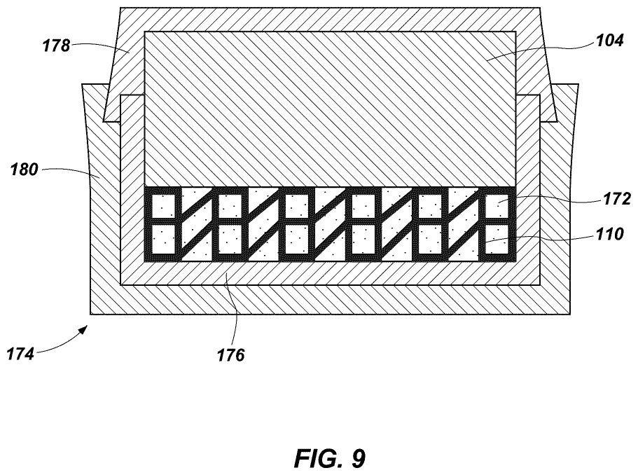

Regarding the sintering process, FIG. 9 illustrates the three-dimensional structure 110 of FIGS. 3 and 4 with particulate material 172 disposed in the open pore network 112 defined by the beams 114 of the three-dimensional structure 110, within a canister 174. The canister 174 may include an inner cup 176 in which the particulate material 172 may be disposed. If the polycrystalline diamond compact 100 is to include a substrate 104 (FIG. 2), the substrate 104 optionally may also be provided in the inner cup 176 over or under the three-dimensional structure 110 with the particulate material 172 disposed therein and may ultimately be encapsulated in the canister 174. The canister 174 may further include a top end piece 178 and a bottom end piece 180, which may be assembled and bonded together (e.g., swage bonded) around the inner cup 176 with the three-dimensional structure 110, particulate material 172, and the optional substrate 104 therein. The sealed canister 174 then may be subjected to a sintering process as described herein to form the hard polycrystalline material 102 of the polycrystalline diamond compact 100 (FIG. 2).

The composition of the particulate material 172 may be varied as desired to (in combination with the composition of the three-dimensional structure 110) achieve a desired composition in the resulting polycrystalline diamond compact 100. The particulate material 172 may comprise metal particles, metal alloy particles, hard particles (e.g., diamond grains), or a mixture of such particles. In some embodiments, the particulate material 172 may comprise only metal or metal alloy, and no hard particles. In other embodiments, the particulate material 172 may include hard particles and no metal or metal alloy. In yet further embodiments, the particulate material 172 may include a mixture of metal or metal alloy and hard particles. As a non-limiting example, the particulate material 172 may comprise diamond particles and particles of a cobalt-, iron-, or nickel-based alloy. The diamond particles and the metal alloy particles may have average grain sizes of between 10 nm and 100μm.

The relative weight or volume percentages for the diamond and metal alloy particles may range from 0% metal alloy particles and 100% diamond particles to 100% metal alloy particles and 0% diamond particles. As non-limiting examples, the particulate material 172 may comprise 100% metal or metal alloy particles and 0% hard particles, 90% metal or metal alloy particles and 10% hard particles, 75% metal or metal alloy particles and 25% hard particles, 60% metal or metal alloy particles and 40% hard particles, 50% metal or metal alloy particles and 50% hard particles, 40% metal or metal alloy particles and 60% hard particles, 25% metal or metal alloy particles and 75% hard particles, or 10% metal or metal alloy particles and 90% hard particles, wherein the percentages are weight percentages.

In HTHP sintering processes, the sintering cycle may commence by ramping the pressure within the HTHP press up to a maximum sintering pressure. In some embodiments, the maximum sintering pressure may be between about 5.0 GPa and about 14 GPa. The temperature may also be ramped up to a maximum sintering temperature. In some embodiments, the maximum sintering temperature may be at least about 1300° C. The canister 174 with the three-dimensional structure 110 and particulate material 172 therein may be subjected to pressures of at least about 5.0 GPa and temperatures of at least about 1300° C. for a time period extending from a few seconds to several minutes or more, although it may be desirable to reduce the sintering time period so as to hinder grain growth in the hard polycrystalline material 102. The temperature in the press may be ramped down from the maximum sintering temperature, and the pressure in the press may be ramped down from the maximum sintering pressure.

As is known in the art, during the sintering process, the canister 174 is typically surrounded by a material that will not melt during the sintering process, and the canister 174 itself will melt. Upon cooling, the material that previously formed the canister 174 solidifies around the polycrystalline compact 100. It is known in the art to include mica films within the canister 174 to enable easy separation of the finished hard polycrystalline material 102 (and substrate 104) from the metal canister 174 after the sintering process. Alternatively, the canister 174 can be removed from the hard polycrystalline compact using conventional machining processes (e.g., milling, turning, grinding, etc.).

Optionally, the polycrystalline compact 100 may be leached in selective regions to leach interstitial material (e.g., cobalt) out from interstitial spaces between inter-bonded diamond crystals in the compact 100 using, for example, an acid or combination of acids (e.g., aqua regia). A substantial amount of the interstitial material may be removed from the compact 100, or the interstitial material may be removed from only a portion thereof, such as from a cutting face, from a side of the compact 100, or both, to a desired depth within the compact 100, but without leaching all of the interstitial material out from the compact 100.

The formation and use of the three-dimensional structures as described herein, such as the three-dimensional structure 110 of FIGS. 3-4, allows more control and flexibility in precisely and selectively varying the composition and microstructure within the hard polycrystalline compact, such as the polycrystalline diamond table 10 of FIG. 2, relative to previously known methods of manufacturing such hard polycrystalline compacts. As a result, the hard polycrystalline compacts may be formed with different regions having different compositions, different microstructures, or both different compositions and microstructures, where the compositions and microstructures are tailored to be more suitable for the forces, stresses, temperatures, and conditions to which those regions are respectively subjected during use of the hard polycrystalline compacts. For example, the volumetric amount of hard polycrystalline material may be selectively varied within the hard polycrystalline material, and/or interstitial spaces between interbonded hard material grains in the first region may be occupied with a first interstitial composition, and interstitial spaces between interbonded hard material grains in the second region may be occupied with a second interstitial composition different from the first interstitial composition. As a result, the performance and durability of the hard polycrystalline compacts may be improved relative to previously known hard polycrystalline compacts.

Polycrystalline compacts that embody teachings of the present disclosure, such as the polycrystalline compact 100 illustrated in FIG. 2, may be formed and secured to earth-boring tools for use in forming wellbores in subterranean formations. As a non-limiting example, FIG. 10 illustrates a fixed cutter type earth-boring rotary drill bit 200 that includes a plurality of polycrystalline compacts 100 as previously described herein. The earth-boring rotary drill bit 200 includes a bit body 202, and the polycrystalline compacts 100, which serve as cutting elements, are mounted on the bit body 202 of the drill bit 200. The polycrystalline compacts 100 may be brazed or otherwise secured within pockets formed in the outer surface of the bit body 202. Other types of earth-boring tools, such as roller cone bits, percussion bits, hybrid bits, reamers, etc., also may include cutting elements 100 as described herein.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of forming a polycrystalline diamond compact for use in an earth-boring tool, comprising:
forming a three-dimensional structure comprising an open pore network, the three-dimensional structure comprising at least one of a metal or metal alloy or diamond grains;
disposing particulate material within the three-dimensional structure, the particulate material comprising at least one of a metal or metal alloy or diamond grains; and
subjecting the three-dimensional structure with the particulate material therein to a high-temperature, high-pressure (HTHP) sintering process to form the polycrystalline diamond compact.

2. The method of claim 1, wherein forming the three-dimensional structure comprises using an additive manufacturing process to form the three-dimensional structure, the additive manufacturing process including:
forming at least one layer of unconsolidated particulate matter; and
consolidating predetermined regions of the at least one layer of unconsolidated particulate matter using an energy beam; and
removing remailing unconsolidated particulate matter from the at least one layer of unconsolidated particulate matter.

3. The method of claim 1, wherein forming the three-dimensional structure comprises using an additive manufacturing process to form the three-dimensional structure, the additive manufacturing process including:
mixing particulate matter with an organic binder to form a slurry, the particulate matter comprising the at least one of a metal or metal alloy or diamond grains; and
selectively depositing the slurry mixture at predetermined locations on a substrate using a nozzle, the organic binder solidifying upon deposition of the slurry mixture on the substrate to retain the particulate matter and the organic binder at the predetermined locations at which they were deposited.

4. The method of claim 1, wherein forming the three-dimensional structure comprises using a freeze-casting process to form the three-dimensional structure.

5. The method of claim 1, wherein the three-dimensional structure has a first composition in a first region of the three-dimensional structure and a second composition different from the first composition in a second region of the three-dimensional structure.

6. The method of claim 1, wherein the three-dimensional structure comprises at least one of a metal or metal alloy, the three-dimensional structure being free of diamond grains.

7. The method of claim 1, wherein the three-dimensional structure comprises the at least one of a metal or metal alloy and diamond grains.

8. The method of claim 1, wherein the three-dimensional structure comprises the diamond grains and a binder, the three-dimensional structure being free of metal or metal alloy.

9. The method of claim 1, wherein subjecting the three-dimensional structure with the particulate material therein to the HTHP sintering process to form the polycrystalline diamond compact further comprises:
forming a first region of the polycrystalline diamond compact comprising a cutting edge of the polycrystalline diamond compact; and
forming a second region of the polycrystalline diamond compact remote from the cutting edge of the polycrystalline diamond compact;
wherein interstitial spaces between interbonded diamond grains in the first region are occupied with a first interstitial composition, and interstitial spaces between interbonded diamond grains in the second region are occupied with a second interstitial composition different from the first interstitial composition.

10. The method of claim 1, wherein the three-dimensional structure comprises a lattice structure.

11. The method of claim 1, wherein the three-dimensional structure comprises a random structure.

12. The method of claim 1, wherein the three-dimensional structure comprises a metal alloy including one or more Group VIII metal elements.

13. The method of claim 12, wherein the metal alloy further includes one or more metal elements selected from among the group consisting of Ti, Zr, V, Nb, Ta, Cr, Mo, W, Mn, Re, Cu, Ag, Au, Zn, and Al.

14. The method of claim 13, wherein the metal alloy further includes one or more elements selected from among the group consisting of Mg, Ca, B, C, Si, N, P, O, and S.

15. A method of forming a polycrystalline diamond compact for use in an earth-boring tool, comprising:
providing a three-dimensional structure comprising an open pore network, the three-dimensional structure comprising at least one of a metal or metal alloy or diamond grains;
disposing particulate material within the three-dimensional structure; and
subjecting the three-dimensional structure with the particulate material therein to a high-temperature, high-pressure (HTHP) sintering process to form the polycrystalline diamond compact.

16. The method of claim 15, wherein the three-dimensional structure has a first composition in a first region of the three-dimensional structure and a second composition different from the first composition in a second region of the three-dimensional structure.

17. The method of claim 15, wherein the three-dimensional structure comprises the at least one of a metal or metal alloy, the three-dimensional structure being free of diamond grains.

18. The method of claim 15, wherein the three-dimensional structure comprises the at least one of a metal or metal alloy and diamond grains.

19. The method of claim 15, wherein the three-dimensional structure comprises the diamond grains and a binder, the three-dimensional structure being free of metal or metal alloy.

20. A hard polycrystalline compact formed using a method according to claim 1.
